(19) United States
(12) Patent Application Publication
(10) Pub. No.: US 2018/0353819 A1
(43) Pub. Date: Dec. 13, 2018

(54) Golf Flagstick with Force Absorption Characteristics

(71) Applicant: Michael Debono, Irving, TX (US)

(72) Inventor: Michael Debono, Irving, TX (US)

(21) Appl. No.: 16/001,385

(22) Filed: Jun. 6, 2018

Related U.S. Application Data
(60) Provisional application No. 62/516,820, filed on Jun. 8, 2017.

(51) Int. Cl. A63B 57/30; B32B 5/18; B32B 25/04; B32B 27/06; B32B 7/12

(52) U.S. Cl. CPC A63B 57/357; B32B 5/18; B32B 25/04; A63B 2102/32; B32B 7/12; A63B 2209/00; B32B 27/06

(57) ABSTRACT

In one embodiment, a golf flagstick is disclosed including a resilient material that absorbs force delivered by a golf ball to reduce spacing between the ball and the flagstick after the ball comes to rest. In another embodiment, a golf flagstick is disclosed including a shaft, and an outer cover positioned about the shaft that includes the resilient material. In another embodiment, the outer cover may be a standalone item usable with an existing golf flagstick. In another embodiment, the outer cover may be provided as a component of a kit to retrofit an existing golf flagstick. In another embodiment, a method of increasing force absorption of a golf flagstick is disclosed to reduce spacing between the flagstick and a golf ball striking the flagstick after the ball comes to rest. The method includes adding a resilient material to the flagstick to absorb force delivered by the ball.

### CROSS-REFERENCE TO RELATED APPLICATIONS

This application claims the benefit of, and priority to, U.S. Patent Application Ser. No. 62/516,820, filed on Jun. 8, 2017, the entire content of which is hereby incorporated by reference.

### TECHNICAL FIELD

The present disclosure relates generally to golf flagsticks, and more specifically, to a golf flagstick with increased force absorption capabilities to reduce spacing between the golf flagstick and a golf ball striking the flagstick after the golf ball comes to rest.

### BACKGROUND

On a golf course, flagsticks are used to mark the position of the cup (hole) in the green and are typically formed from rigid materials, such as fiberglass, wood, and/or metal(s). Unfortunately, however, in the event that a golf ball strikes the flagstick during flight, the golf ball often ricochets, sometimes ending up a significant distance from the cup, off the green, or in a hazard near the green, effectively penalizing the player for a quality golf shot. One famous example is Tiger Woods' approach shot on the fifteenth hole of The Masters at Augusta National Golf Club in 2013, which struck the flagstick and spun backwards into the greenside water hazard.

The present disclosure addresses such inequities in the game of golf by providing a flagstick with increased force absorption capabilities such that a golf ball striking the flagstick comes to rest closer to the cup.

### SUMMARY

In accordance with one aspect of the present disclosure, a golf flagstick is disclosed that includes an outer cover. The outer cover includes (e.g., is formed entirely or partially from) a resilient material to absorb force delivered by a golf ball striking the flagstick to reduce spacing between the golf ball and the flagstick after the golf ball comes to rest.

In certain embodiments, the outer cover may be deformable from an initial configuration to a subsequent configuration upon being struck by the golf ball to absorb a substantial percentage (e.g., 10%, 25%, or more) of the force delivered by the golf ball upon the flagstick.

In certain embodiments, the resilient material may be selected from the group consisting of: polyurethane foam, rubber, polymers, closed-cell polyurethane foam rubber, and a shock absorbing gel.

In certain embodiments, the outer cover may include an inner layer, an outer layer, and an intermediate layer positioned between the inner and outer layers. In such embodiments, the intermediate layer may include one or more materials selected from the group consisting of: polyurethane foam, rubber, polymers, closed-cell polyurethane foam rubber, and a shock absorbing gel.

In certain embodiments, the outer cover may be uniform in construction.

In certain embodiments, the outer cover may include a water-resistant material.

In certain embodiments, the flagstick may further include a reflector to facilitate distance measurement from the flagstick (e.g., via a laser rangefinder).

In certain embodiments, the reflector may be secured to, or embedded in, the outer cover.

In another aspect of the present disclosure, a golf flagstick is disclosed that includes a shaft made from a first material, and an outer cover positioned about the shaft made from a second material different than the first material. The second material is resilient to absorb force delivered by a golf ball striking the flagstick.

In certain embodiments, the second material may be flexible in relation to the first material.

In certain embodiments, the first material may have a first durometer, and the second material may have a second, lower durometer.

In certain embodiments, the second material may be resiliently deformable such that the outer cover is deformable from an initial configuration to a subsequent configuration upon being struck by the golf ball to absorb a substantial percentage (e.g., 10%, 25%, or more) of the force delivered by the golf ball upon the flagstick.

In certain embodiments, the outer cover may include one or more materials selected from the group consisting of: polyurethane foam, rubber, polymers, closed-cell polyurethane foam rubber, and a shock absorbing gel.

In certain embodiments, the shaft may be configured as a rod.

In certain embodiments, the outer cover may define a thickness within the range of approximately ¼″ to approximately 1″.

In certain embodiments, the outer cover may extend along a portion of the length of the shaft such that the flagstick defines an overall outer dimension (e.g., a diameter) that varies along its length.

In certain embodiments, the outer cover may include an inner, an outer layer, and an intermediate layer positioned between the inner and outer layers.

In certain embodiments, the intermediate layer may include one or more materials selected from the group consisting of: polyurethane foam, rubber, polymers, closed-cell polyurethane foam rubber, and a shock absorbing gel.

In certain embodiments, the outer cover may be uniform in construction.

In certain embodiments, the outer cover may include a water-resistant material.

In certain embodiments, the outer cover may be fixedly secured to the shaft.

In certain embodiments, the outer cover may be secured to the shaft using an adhesive.

In certain embodiments, the outer cover may be removably secured to the shaft.

In certain embodiments, the outer cover may be mechanically secured to the shaft.

In certain embodiments, the outer cover may be secured to the shaft using a clamp.

In certain embodiments, the flagstick may further include a reflector to facilitate distance measurement from the flagstick (e.g., via a laser rangefinder).

In certain embodiments, the reflector may be embedded in the outer cover.

In certain embodiments, the reflector may be secured to the outer cover.

In certain embodiments, the reflector may be visible through the outer cover.

In another aspect of the present disclosure, an outer cover (sheath) is disclosed that is configured and dimensioned for use with a golf flagstick. The outer cover is configured and dimensioned for positioning about the flagstick and includes a resilient material to absorb force delivered by a golf ball striking the outer cover.

In certain embodiments, the outer cover may be deformable such that the outer cover is deformable from an initial configuration to a subsequent configuration upon being struck by the golf ball to absorb a substantial percentage of the force (e.g., 10%, 25%, or more) delivered by the golf ball striking the outer cover.

In certain embodiments, the outer cover may include one or more materials selected from the group consisting of: polyurethane foam, rubber, polymers, closed-cell polyurethane foam rubber, and a shock absorbing gel.

In certain embodiments, the outer cover may define a thickness substantially within the range of approximately ¼″ to approximately 1″.

In certain embodiments, the outer cover may include an inner layer, an outer layer, and an intermediate layer positioned between the inner and outer layers.

In certain embodiments, the intermediate layer may include one or more materials selected from the group consisting of: polyurethane foam, rubber, polymers, closed-cell polyurethane foam rubber, and a shock absorbing gel.

In certain embodiments, the outer cover may be uniform in construction.

In certain embodiments, the outer cover may include a water-resistant material.

In certain embodiments, the outer cover may further include a reflector to facilitate distance measurement from the flagstick (e.g., via a laser rangefinder).

In certain embodiments, the reflector may be embedded in the outer cover.

In certain embodiments, the reflector may be secured to the outer cover.

In certain embodiments, the outer cover may define an opening configured and dimensioned to reveal a reflector to facilitate distance measurement from the flagstick (e.g., via a laser rangefinder).

In another aspect of the present disclosure, a kit is disclosed for use with a golf flagstick. The kit includes an outer cover that is configured and dimensioned for positioning about the flagstick.

The outer cover includes a resilient material to absorb force delivered by a golf ball striking the outer cover and thereby reduce spacing between the golf ball and the flagstick after the golf ball comes to rest.

In certain embodiments, the outer cover may be deformable such that the outer cover is resiliently reconfigurable between an initial configuration and a subsequent configuration upon being struck by the golf ball to absorb a substantial percentage (e.g., 10%, 25%, or more) of the force delivered by the golf ball striking the outer cover.

In certain embodiments, the outer cover may include one or more materials selected from the group consisting of: polyurethane foam, rubber, polymers, closed-cell polyurethane foam rubber, and a shock absorbing gel.

In certain embodiments, the outer cover may define a thickness substantially within the range of approximately ¼″ to approximately 1″.

In certain embodiments, the outer cover may include an inner layer, an outer layer, and an intermediate layer positioned between the inner and outer layers.

In certain embodiments, the intermediate layer may include one or more materials selected from the group consisting of: polyurethane foam, rubber, polymers, closed-cell polyurethane foam rubber, and a shock absorbing gel.

In certain embodiments, the outer cover may be uniform in construction.

In certain embodiments, the outer cover may include a water-resistant material.

In certain embodiments, the kit may further include an attachment member to secure the outer cover to the flagstick.

In certain embodiments, the attachment member may include an adhesive.

In certain embodiments, the attachment member may include a mechanical connector.

In certain embodiments, the mechanical connector may include a clamp.

In certain embodiments, the mechanical connector may include a tie (e.g., a ratcheting tie).

In another aspect of the present disclosure, a method is disclosed for increasing the force absorption capabilities of a golf flagstick to reduce spacing between the flagstick and a golf ball striking the flagstick after the golf ball comes to rest.

The method includes adding a resilient material to the flagstick that is adapted to absorb force delivered by the golf ball striking the flagstick.

In certain embodiments, adding the resilient material may include covering a shaft of the flagstick with the resilient material.

In certain embodiments, covering the shaft of the flagstick may include inserting the shaft into a cover through an opening in the cover, wherein the cover includes (e.g., is formed partially or entirely from) the resilient material.

In certain embodiments, inserting the shaft into the cover through the opening may include inserting the flagstick into the opening laterally.

In certain embodiments, inserting the shaft into the cover through the opening may include inserting the shaft into the opening longitudinally.

In certain embodiments, adding the resilient material to the flagstick may include adding a deformable material to the flagstick such that the material is resiliently reconfigurable between an initial configuration and a subsequent configuration upon being struck by the golf ball to absorb a substantial percentage (e.g., 10%, 25%, or more) of the force delivered by the golf ball upon the flagstick.

In certain embodiments, adding the resilient material to the flagstick may include adding one or more materials selected from the group consisting of: polyurethane foam, rubber, polymers, closed-cell polyurethane foam rubber, and a shock absorbing gel.

In certain embodiments, adding the resilient material to the flagstick may include adding a plurality of layers of material to the flagstick including an inner layer, an outer layer, and an intermediate layer positioned between the inner and outer layers.

In certain embodiments, adding the plurality of layers of material to the flagstick may include adding the intermediate layer such that the intermediate layer is positioned between the inner and outer layers. In such embodiments, the intermediate layer may include one or more materials selected from the group consisting of: polyurethane foam, rubber, polymers, closed-cell polyurethane foam rubber, and a shock absorbing gel.

In certain embodiments, adding the resilient material to the flagstick may include adding a water-resistant material to the flagstick.

In certain embodiments, the method may further include connecting the cover to the flagstick using an attachment member to secure the resilient material to the flagstick.

In certain embodiments, connecting the cover to the flagstick may include connecting the cover to the flagstick using an adhesive.

In certain embodiments, connecting the cover to the flagstick may include mechanically connecting the cover to the flagstick.

In certain embodiments, mechanically connecting the cover to the flagstick may include connecting the cover to the flagstick using a clamp.

In certain embodiments, mechanically connecting the cover to the flagstick may include connecting the cover to the flagstick using a tie (e.g., a ratcheting tie).

### BRIEF DESCRIPTION OF THE FIGURES

Various embodiments of the present disclosure are described herein with reference to the accompanying drawings. In accordance with common practice, the various features of the drawings may not be to-scale and may be arbitrarily expanded or reduced for clarity.

FIG. 1 is a front, perspective view of golf green including a cup and a golf flagstick in accordance with the principles of the present disclosure;

FIG. 2 is a top, perspective view of the flagstick seen in FIG. 1 including one embodiment of an outer cover;

FIG. 3A is a transverse, cross-sectional view of the flagstick taken along line 3-3 in FIG. 2;

FIG. 3B is a transverse, cross-sectional view of an alternate embodiment of the flagstick including an outer cover;

FIG. 4 is a transverse, cross-sectional view of an alternate embodiment of the flagstick;

FIGS. 5 and 6 are front views of the flagstick together with alternate embodiments of attachment members used in securing an outer cover to a shaft of the flagstick;

FIG. 7 is a transverse, cross-sectional view of one embodiment of an outer cover for a golf flagstick;

FIG. 8 is a transverse, cross-sectional view of another embodiment of an outer cover for a golf flagstick; and

FIG. 9 illustrates a kit for use in connection with a golf flagstick.

### DETAILED DESCRIPTION

The present disclosure describes a golf flagstick that is designed to absorb the force delivered by a golf ball striking the flagstick to reduce spacing between the flagstick and the golf ball once the golf ball comes to rest. In certain embodiments of the present disclosure, a novel golf flagstick is disclosed that includes a resilient outer cover. In other embodiments, an outer cover is disclosed for use with existing golf flagsticks such that existing flagsticks can be modified.

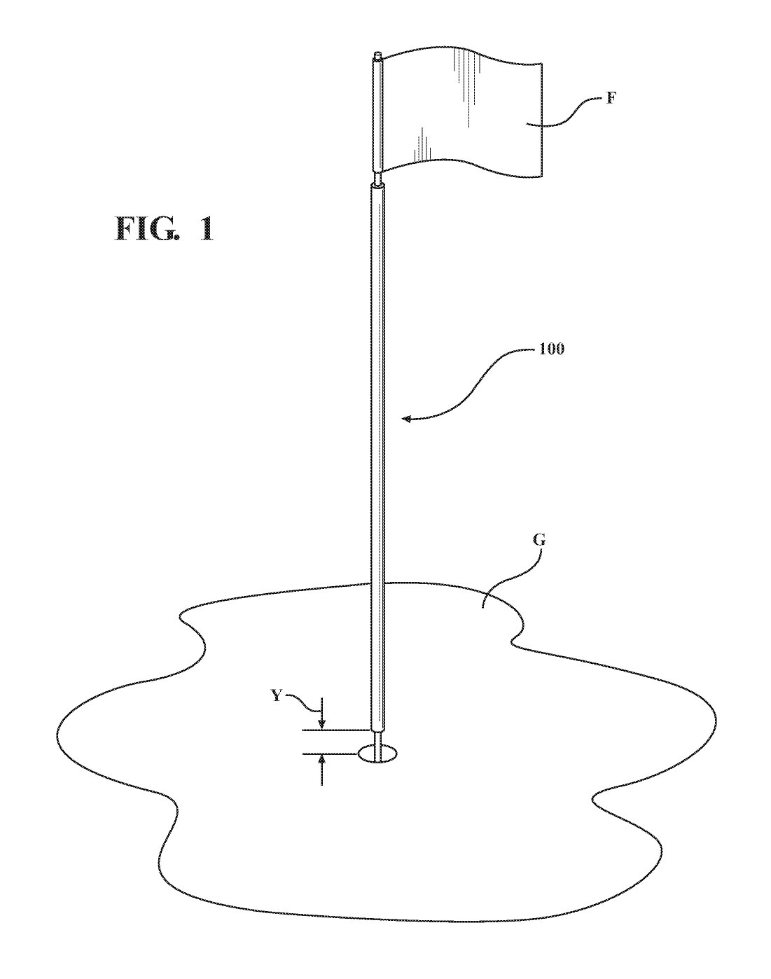

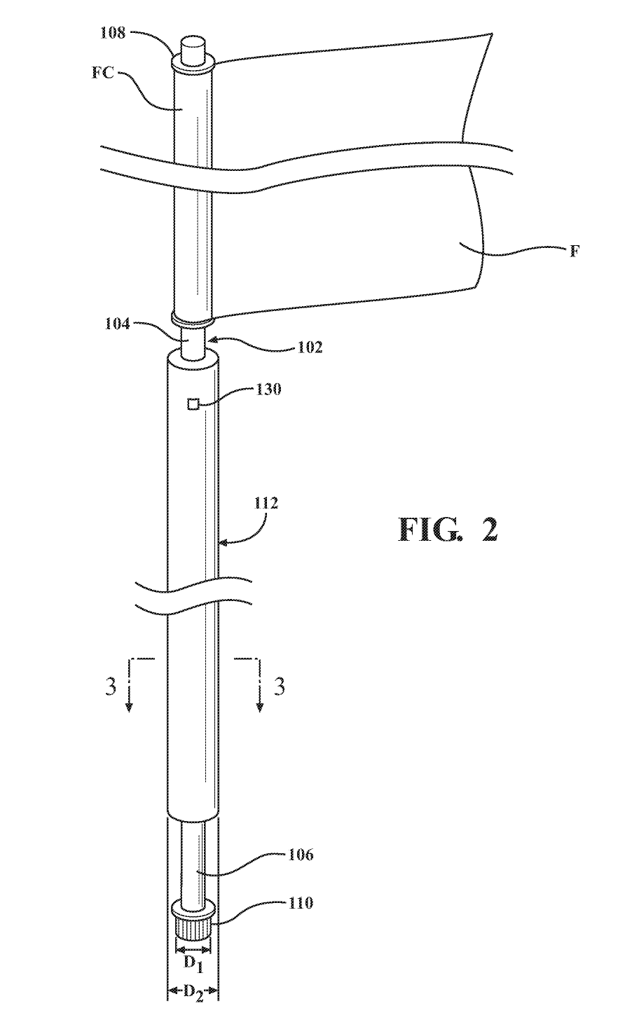

With reference to FIGS. 1-4, a golf flagstick 10 according to the principles of the present disclosure is shown positioned within a cup “C” to mark the position of the cup “C” in a golf green “G”. The flagstick 100 includes a shaft 102 configured as a rod 104 having respective lower and upper ends 106, 108 (FIG. 2) and defining an outermost dimension D₁ (e.g., a diameter). In various embodiments, it is envisioned that the rod 104 may be solid, that the rod 104 may define one or more internal openings or cavities (e.g., in the form of a honeycomb structure), that the rod 104 may be hollow, or any combination of the above. For example, an embodiment in which the rod 104 includes solid sections (e.g., near or adjacent the ends 106, 108) separated by one or more hollow intermediate sections would be within the scope of the present disclosure. The shaft 102 may include (e.g., may be formed from) any material suitable for the intended purpose of supporting the flagstick 100 in an upright, vertical position when inserted in the cup “C.” For example, the shaft 102 may include (e.g., may be formed from) fiberglass, one or more metallic materials, such as steel, polymeric materials, carbon fiber, carbon nanotubes, etc., either individually or in combination. As is conventional, the lower end 106 of the shaft 102 includes a ferrule 110 (FIG. 2) that is configured and dimensioned for receipt by an opening formed in the base of the cup “C” such that the flagstick 100 remains upright in the cup “C,” and the upper end 108 of the shaft 102 is configured and dimensioned to support a flag “F.” Conventionally, the flag “F” is supported at the upper end 108 of the shaft 102 by a flag carrier “FC”, which is often configured as a tube, collet, flange, socket, or other such structure that is positionable about the shaft 102.

The flagstick 100 includes an outer cover 112 disposed about the shaft 102. The outer cover 112 may extend along a portion of the length of the shaft 102, as seen in FIG. 2, such that the outer cover 112 terminates at a location on the shaft 102 spaced a distance “Y” (FIG. 1) from the surface of the green “G” when the flagstick 100 is inserted in the cup “C.” In the particular embodiment illustrated in FIG. 2, for example, the outer cover 112 is dimensioned and positioned such that the distance “Y” is approximately is three inches (3″). The dimensions and position of the outer cover 112 may be varied in alternate embodiments of the flagstick 100, however, in order to realize any desired distance “Y”. An embodiment of the flagstick is also envisioned in which the outer cover 112 extends along the entire length of the shaft 102. Thus, in certain embodiments, the flagstick 100 may define an outermost dimension D₂ that varies along the length of the flagstick 100, as seen in FIG. 2, whereas in other embodiments, the flagstick 100 may define an outermost dimension D₂ that is uniform along the length of the flagstick 100.

The outer cover 112 includes (e.g., is formed from) a resilient, shock absorbent material which may be any material suitable for the intended purpose of absorbing the force delivered by a golf ball impacting the flagstick 100 to minimize or reduce the distance between the flagstick 100 and the point at which the golf ball comes to rest (when compared to conventional flagsticks). Thus, in certain embodiments of the flagstick 100, it is envisioned that the shaft 102 and the outer cover 112 may include (e.g., may be formed from) different materials. For example, the shaft 102 may include (e.g., may be formed partially or entirely from) a first material and the outer cover 112 may include (e.g., may be formed partially or entirely from) a second material that is more flexible or compliant than the first material. For example, the first material may have a first durometer and the second material may have a second durometer lower than the first durometer. In one particular embodiment, for instance, the shaft 102 may include (e.g., may be formed from) carbon fiber or steel and the outer cover 112 may include (e.g., may be formed from) a closed-cell polyurethane foam rubber.

It is envisioned that the material used in construction/fabrication of the outer cover 112 may be resiliently deformable such that, upon impact by a golf ball, the outer cover 112 may resiliently deform during shock absorption. More specifically, upon impact by a golf ball, the outer cover 112 may be moved from an initial (un-deformed) configuration to a subsequent (deformed) configuration. The outer cover 112 may then either return to the initial configuration or to a configuration that closely approximates the initial configuration. By way of example, the following non-exhaustive list of materials may be used in fabrication of the outer cover 112, either individually, or in combination: memory foam, such as a polyurethane foam, rubberized materials, polymeric materials, closed-cell polyurethane foam rubber, shock absorbing gels, liquids, powders, a honeycomb structure, etc. Dependent upon the materials of construction used in fabrication of the shaft 102 and the outer cover 112, it is envisioned that the flagstick 100 may absorb a substantial percentage of the force delivered by a golf ball upon the flagstick 100. For example, it is envisioned that the flagstick 100 may absorb 10%, 25%, 50%, 75%, or more of the force delivered by the golf ball.

In those embodiments employing a more rigid shaft 102 (e.g., an embodiment in which the rod 104 is formed from steel), the dimension D₁ may be reduced without sacrificing stability, thereby allowing for added thickness in the outer cover 112 without increasing the outermost dimension D₂ of the flagstick 100. Thus, depending on the materials of construction used in fabrication of the shaft 102 and the outer cover 112 (e.g., the materials from which the shaft 102 and the outer cover 112 are formed), and the dimensions of the shaft 102, it is envisioned that the thickness of the outer cover 112 (i.e., D₂−D₁) may vary. For example, it is envisioned that the thickness of the outer cover 112 may lie substantially within the range of approximately ⅛″ to approximately 2″. As such, embodiments of the flagstick 100 are contemplated in which the ratio of D₂:D₁ may be 1:1, 2:1, 3:1, 6:1, 8:1, 10:1, or more, dependent upon the materials of construction used in fabrication of the shaft 102 and the outer cover 112.

In one particular embodiment, it is envisioned that the flagstick 100 may be configured and dimensioned, and that the materials of construction used in fabrication of the shaft 102 and the outer cover 112 may be chosen, such that the outer dimension D₁ of the shaft 102 will lie substantially within the range of approximately ¼″ to approximately ½″ and the outer dimension D₂ of the outer cover will lie substantially within the range of approximately ½″ to approximately ¾,″ whereby the flagstick 100 will define an outermost dimension D₂ (FIG. 2) that lies substantially within the range of approximately ¾″ to approximately 1″.

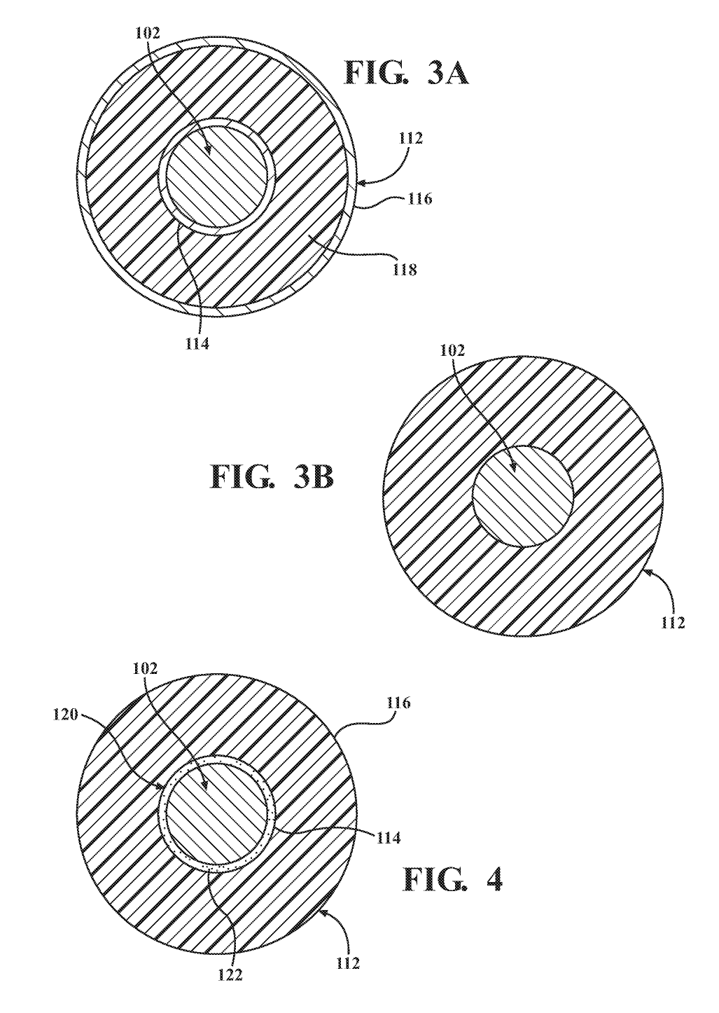

With reference to FIG. 3A, in one embodiment, the outer cover 112 may include a plurality of layers. For example, the outer cover 112 may include inner and outer layers 114, 116, respectively, and an intermediate layer 118 (i.e., a filler) positioned between the layers 114, 116. In such embodiments, one or more of the layers 114, 116, 118 may include any of the materials listed above (i.e., a memory foam, such as a polyurethane foam, rubberized materials, polymeric materials, closed-cell polyurethane foam rubber, shock absorbing gels, liquids, powders, a honeycomb structure, etc., either individually or in combination). Alternatively, it is envisioned that the outer cover 112 may be uniform in construction, and devoid of any layers. In such embodiments, the outer cover 112 may be formed from a single piece, sheet, or composition of material, as shown in FIG. 3B.

It is further envisioned that the material of construction used in fabrication of the outer cover 112 may include one or more water-resistant materials (e.g., to increase the usable life of the flagstick 100). For example, the outer cover 112 may include a water-resistant skin or coating, or the material of construction used in fabrication of the outer cover 112 itself may be water-resistant.

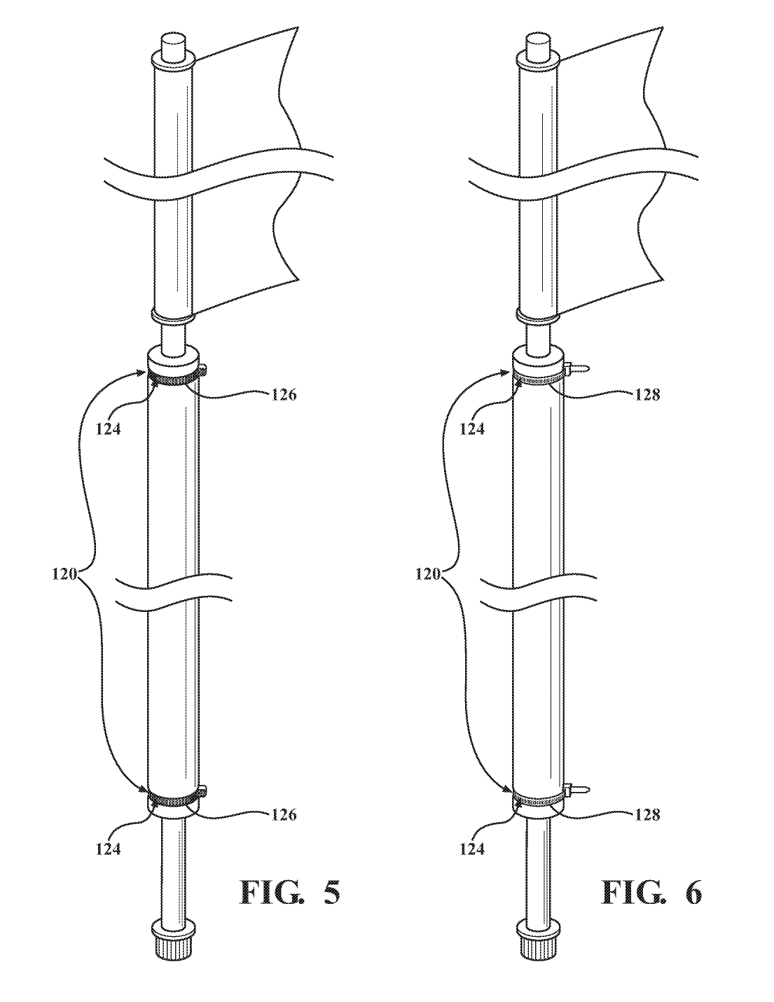

The outer cover 112 may be secured to the shaft 102 in any suitable manner, and may be either fixedly or removable secured to the shaft 102. For example, the outer cover 112 may be secured to the shaft 102 through the use of an attachment member 120 (FIGS. 4-6), such as an adhesive 122 (FIG. 4) or the like. Additionally, or alternatively, a mechanical connector 124 may be used to secure the outer cover 112 to the shaft 102. Suitable examples of mechanical connectors 124 include, but are not limited to, screw clamps 126 (FIG. 5), a ratcheting tie-down element 128 (FIG. 6), over-center clamps (not shown), etc. In those embodiments in which the outer cover 112 is releasably connected to the shaft 102, the outer cover 112 may be separated from the shaft 102 to facilitate maintenance and/or replacement of the outer cover 112.

In certain embodiments, the flagstick 100 may include a reflector 130 (FIG. 2) to facilitate use with a laser ranger finder, or other such instrument, to measure distance between an observer/player and the flagstick 100. In such embodiments, it is envisioned that the reflector 130 may be secured to the outer cover 112, as seen in FIG. 2, or that the reflector 130 may be embedded within the outer cover 112. Alternatively, it is envisioned that the reflector 130 may be visible through a cutout or a window formed in the outer cover 112.

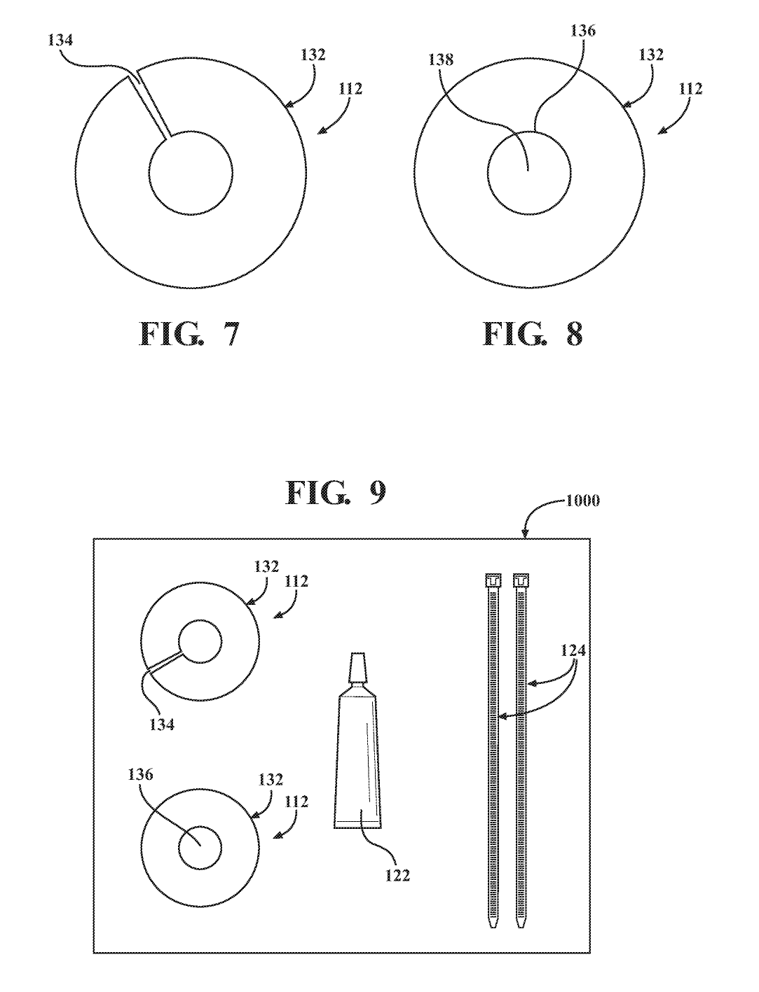

With reference now to FIGS. 7 and 8, it is envisioned that the outer cover 112 may be provided as a standalone item that can be secured to an existing flagstick (e.g., a conventional fiberglass or steel flagstick in current use) to allow for modification of the flagstick and realization of the advantages provided by the outer cover 112. In such embodiments the outer cover 112 may be provided in the form of a sheath (sleeve) 132 that can be fixedly or removably secured to the flagstick in the manner discussed above (e.g., via an adhesive and/or a mechanical connector).

In one embodiment, shown in FIG. 7, the sheath 132 may include a slit 134 extending along the length of the sheath 132 to allow the flagstick to be laterally inserted into the outer cover 112. Alternatively, as seen in FIG. 8, the sheath 132 may include a longitudinal opening 136 defining an internal channel 138 that is configured and dimensioned to receive the flagstick. In such embodiments, the flagstick may be longitudinally inserted into the sheath 132.

The outer cover 112 may be provided as part of a kit 1000 (FIG. 9), which may include the aforementioned adhesive 122 and/or one or more of the aforementioned mechanical connectors 126. In the embodiment shown in FIG. 9, the kit 1000 includes two varieties of the outer cover 112 in the form of the sheath 132: one including the slit 134 and another including the longitudinal opening 136.

With reference now to FIGS. 1-8, a method for increasing the force absorption of a golf flagstick will be discussed in order to reduce spacing between the golf flagstick and a golf ball striking the flagstick after the golf ball comes to rest.

In one method, a resilient material is applied to the shaft 102 (FIG. 2) of the golf flagstick 100 during manufacture. For example, the resilient material may be sprayed onto the shaft 102 and allowed to cure so as to form the outer cover 112. Alternatively, the resilient material may be provided in the form of the aforementioned sheath 132 (FIGS. 7, 8) and secured to the shaft 102 during manufacture (e.g., through the use of the adhesive 122 seen in FIG. 4).

Alternatively, an existing golf flagstick may be retrofitted by securing the outer cover 112 to the shaft 102. For example, the outer cover 112 may be secured or mounted to the shaft 102 of the existing golf flagstick, such as through the use of the adhesive 122 (FIGS. 4, 9) and/or through the use of one or more mechanical connectors 124 (FIGS. 5, 6, 9).

Persons skilled in the art will understand that the various exemplary aspects of the present disclosure described herein, and shown in the accompanying figures, constitute non-limiting examples of the present disclosure, and that additional components and features may be added to any of the embodiments discussed herein above without departing from the scope of the present disclosure. For example, it is envisioned that the materials of construction used in fabrication of the outer cover 112 may also be utilized in construction of the flag carrier “FC” (FIG. 2) used to support the flag “F” such that, in the event that a golf ball impacts the flagstick 100 at a location adjacent the flag “F”, the force of the golf ball will be absorbed in the same manner discussed above.

Additionally, persons skilled in the art will understand that the elements and features shown or described in connection with one example of the present disclosure may be combined with those of another without departing from the scope of the present disclosure, and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the disclosure, as are alternative embodiments that may result from combining, integrating, and/or omitting features from any of the disclosed embodiments.

The use of broader terms such as “comprises,” “includes,” and “having” should be understood to provide support for narrower terms such as “consisting of,” “consisting essentially of,” and “comprised substantially of.” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “upward,” “downward,” “inward,” “outward,” etc., should be understood to describe a relative relationship between structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated. For example, it is intended that the use of terms such as “approximately” and “generally” should be understood to encompass variations on the order of 25%, or to allow for manufacturing tolerances and/or deviations in design.

Each and every claim is incorporated as further disclosure into the specification, and represents embodiments of the present disclosure. Also, the phrases “at least one of A, B, and C” and “A and/or B and/or C” should each be interpreted to include only A, only B, only C, or any combination of A, B, and C.

What is claimed is:

1. A golf flagstick, comprising:
a shaft; and
an outer cover including a resilient material that absorbs force delivered by a golf ball striking the flagstick to reduce spacing between the golf ball and the golf flagstick after the golf ball comes to rest.

2. The golf flagstick of claim 1, wherein the outer cover is deformable from an initial configuration to a subsequent configuration upon being struck by the golf ballot absorb a substantial percentage of the force delivered by the golf ball upon the flagstick.

3. The golf flagstick of claim 1, wherein the resilient material is selected from the group consisting of: polyurethane foam, rubber, polymers, closed-cell polyurethane foam rubber, and a shock absorbing gel.

4. The golf flagstick of claim 1, wherein the outer cover includes an inner layer, an outer layer, and an intermediate layer positioned between the inner and outer layers.

5. The golf flagstick of claim 4, wherein the intermediate layer includes one or more materials selected from the group consisting of: polyurethane foam, rubber, polymers, closed-cell polyurethane foam rubber, and a shock absorbing gel.

6. The golf flagstick of claim 1, wherein the outer cover is uniform in construction.

7. The golf flagstick of claim 1, wherein the outer cover includes a water-resistant material.

8. A golf flagstick, comprising:
a shaft including a first material; and
an outer cover positioned about the shaft, the outer cover including a second material different than the first material, the second material being resilient to absorb force delivered by a golf ball striking the flagstick.

9. The golf flagstick of claim 11, wherein the second material is flexible in relation to the first material.

10. The golf flagstick of claim 9, wherein the first material has a first durometer, and the second material has a second, lower durometer.

11. The golf flagstick of claim 9, wherein the second material is resiliently deformable such that the outer cover is deformable from an initial configuration to a subsequent configuration upon being struck by the golf ball to absorb a substantial percentage of the force delivered by the golf ball upon the flagstick.

12. The golf flagstick of claim 9, wherein the outer cover includes one or more materials selected from the group consisting of: polyurethane foam, rubber, polymers, closed-cell polyurethane foam rubber, and a shock absorbing gel.

13. The golf flagstick of claim 8, wherein the shaft is configured as a rod.

14. The golf flagstick of claim 8, wherein the outer cover defines a thickness within the range of approximately ¼″ to approximately 1″.

15. The golf flagstick of claim 8, wherein the outer cover extends along a portion of the shaft such that the golf flagstick defines an overall outer dimension that varies along a length of the golf flagstick.

16. The golf flagstick of claim 8, wherein the outer cover includes inner and outer layers, and an intermediate layer positioned between the inner and outer layers.

17. The golf flagstick of claim 16, wherein the intermediate layer includes one or more materials selected from the group consisting of: polyurethane foam, rubber, polymers, closed-cell polyurethane foam rubber, and a shock absorbing gel.

18. The golf flagstick of claim 8, wherein the outer cover is uniform in construction.

19. The golf flagstick of claim 8, wherein the outer cover is fixedly secured to the shaft.

20. The golf flagstick of claim 10, wherein the outer cover is removably secured to the shaft.
